(19) United States
(12) Patent Application Publication
(10) Pub. No.: US 2026/0175298 A1
(43) Pub. Date: Jun. 25, 2026

(54) WIRE NOZZLE, ADDITIVE MANUFACTURING APPARATUS, AND ADDITIVE MANUFACTURING METHOD

(71) Applicant: Mitsubishi Electric Corporation, Tokyo (JP)

(72) Inventors: Yuji MEGURO, Tokyo (JP); Nobuhiro SHINOHARA, Tokyo (JP); Daiji MORITA, Tokyo (JP); Takashi YUZAWA, Tokyo (JP)

(73) Assignee: Mitsubishi Electric Corporation, Tokyo (JP)

(21) Appl. No.: 19/129,024

(22) PCT Filed: Nov. 25, 2022
(86) PCT No.: PCT/JP2022/043480

§ 371 Date: May 12, 2025

(51) Int. Cl. B33Y 30/00

(52) U.S. Cl. CPC B22F 12/53; B22F 10/22; B22F 12/70; B33Y 10/00; B33Y 30/00

(57) ABSTRACT

A wire nozzle is disposed so that at least part thereof is disposed within a range through which a shielding gas passes. The wire nozzle includes a wire tube portion that supplies a manufacturing material that is in the form of a wire to a machining region that is irradiated with heat for melting the manufacturing material and also supplied with the shielding gas. The wire nozzle includes a protrusion that is plate-shaped and protrudes from the wire tube portion toward downstream along a direction of flow of the shielding gas, and the width of the protrusion that is plate-shaped is smaller than or equal to an outer diameter of the wire tube portion.

### FIELD

The present disclosure relates to a wire nozzle for melting and layering a manufacturing material, an additive manufacturing apparatus, and an additive manufacturing method.

### BACKGROUND

Metal additive manufacturing includes a powder bed fusion (PBF) method in which metal powder is spread, and a manufacturing area is irradiated with a laser to be melted and solidified, and a directed energy deposition (DED) method in which materials are melted by focused thermal energy to be bonded and deposited. For inhibiting oxidation of a manufactured object that has been melted to a high temperature, the DED method employs a method of supplying a shielding gas such as argon gas or nitrogen gas from a gas nozzle to a machining region and covering the manufactured object in the machining region with the shielding gas, a method of filling the inside of a chamber including the machining region with the shielding gas, and the like.

When the shielding gas is supplied to the machining region from above, a wire nozzle for supplying a manufacturing material becomes an obstacle, and the manufactured object hidden by the wire nozzle cannot be covered with the shielding gas, whereby the effect of inhibiting oxidation of the manufactured object is reduced. Patent Literature 1 discloses a shielding gas nozzle for metal shaping including: a nozzle including a wire feed line that supplies a wire to a machining region at an angle of inclination, and a gas supply line including a first gas ejection hole that ejects a shielding gas at an angle less than or equal to the angle of inclination; and a diverging gas supply line including a second gas ejection hole that ejects the shielding gas at a different angle from the first gas ejection hole.

### CITATION LIST

### Patent Literature

Patent Literature 1: International Publication No. WO 2020/213051

### SUMMARY OF INVENTION

### Problem to be Solved by the Invention

However, Patent Literature 1 requires a complicated and costly structure including the nozzle, which includes the wire feed line and the gas supply line, and the diverging gas supply line. Furthermore, the structure of Patent Literature 1 has a problem that the area that is shielded from the air is small, and when a relative position between the wire and the manufactured object changes during shaping, the machining region cannot be sufficiently shielded from the entry of the air.

The present disclosure has been made in view of the above, and an object of the present disclosure is to provide a wire nozzle capable of sufficiently shielding a machining region from entry of the air with a simple and inexpensive structure.

### Means to Solve the Problem

In order to solve the above problem and achieve the object, a wire nozzle of the present disclosure is disposed so that at least part of which is disposed within a range through which a shielding gas passes. The wire nozzle includes a wire tube portion that supplies a manufacturing material, which is in the form of a wire, to a machining region that is irradiated with heat for melting the manufacturing material and also supplied with the shielding gas. The wire nozzle includes a protrusion that is plate-shaped and protrudes from the wire tube portion toward downstream along a direction of flow of the shielding gas. The width of the protrusion that is plate-shaped is smaller than or equal to an outer diameter of the wire tube portion.

### Effects of the Invention

The wire nozzle of the present disclosure is capable of sufficiently shielding the machining region from entry of the air with the simple and inexpensive structure.

### BRIEF DESCRIPTION OF DRAWINGS

FIG. 1 is a front view illustrating a configuration of an additive manufacturing system according to a first embodiment.

FIG. 2 is a perspective view illustrating an exemplary configuration of a rotation mechanism of an additive manufacturing apparatus according to the first embodiment.

FIG. 3 is a front view illustrating another exemplary placement of a wire nozzle in the additive manufacturing apparatus according to the first embodiment.

FIG. 4 is a plan view illustrating the other exemplary placement of the wire nozzle in the additive manufacturing apparatus according to the first embodiment.

FIG. 5 is a front view illustrating an exemplary configuration in a case where a laser beam is used as a heat source in the additive manufacturing apparatus according to the first embodiment.

FIG. 6 is a front view illustrating a configuration of a protrusion in the additive manufacturing apparatus according to the first embodiment.

FIG. 7 is a side view illustrating a configuration of the wire nozzle and the protrusion in the additive manufacturing apparatus according to the first embodiment.

FIG. 8 is a front view illustrating a configuration of a first modification of the protrusion in the additive manufacturing apparatus according to the first embodiment.

FIG. 9 is a side view illustrating a configuration of a second modification of the protrusion in the additive manufacturing apparatus according to the first embodiment.

FIG. 10 is a side view illustrating a configuration of a third modification of the protrusion in the additive manufacturing apparatus according to the first embodiment.

FIG. 11 is a plan view illustrating an example of an oxygen concentration distribution on a surface of a deposit in the additive manufacturing apparatus according to the first embodiment.

FIG. 12 is a plan view illustrating an example of an oxygen concentration distribution on the surface of the deposit in a comparative example in which the protrusion is not attached to the wire nozzle.

FIG. 13 is a front view illustrating a configuration of a wire nozzle and a protrusion according to a second embodiment.

FIG. 14 is a side view illustrating a configuration of a wire nozzle and a protrusion according to a third embodiment.

FIG. 15 is a perspective view illustrating the configuration of the wire nozzle and the protrusion according to the third embodiment.

FIG. 16 is a side view illustrating another configuration of the additive manufacturing apparatus according to the third embodiment.

FIG. 17 is a front view illustrating another configuration of the wire nozzle and the protrusion according to the third embodiment.

FIG. 18 is a side view illustrating the other configuration of the wire nozzle and the protrusion according to the third embodiment.

FIG. 19 is a side view illustrating yet another configuration of the additive manufacturing apparatus according to the third embodiment.

FIG. 20 is a side view illustrating a configuration of a wire nozzle and a protrusion according to a fourth embodiment.

FIG. 21 is a front view illustrating the configuration of the wire nozzle and the protrusion according to the fourth embodiment.

FIG. 22 is a front view illustrating a configuration of a first modification of the wire nozzle and the protrusion according to the fourth embodiment.

FIG. 23 is a front view illustrating a configuration of a second modification of the wire nozzle and the protrusion according to the fourth embodiment.

FIG. 24 is a front view illustrating a state in which a protrusion having a first shape is attached to a wire tube portion in an additive manufacturing apparatus according to a fifth embodiment.

FIG. 25 is a front view illustrating a state in which a protrusion having a second shape is attached to the wire tube portion in the additive manufacturing apparatus according to the fifth embodiment.

FIG. 26 is a front view illustrating a state in which a protrusion having a third shape is attached to the wire tube portion in the additive manufacturing apparatus according to the fifth embodiment.

FIG. 27 is a block diagram illustrating a configuration of a machine learning device related to an additive manufacturing apparatus according to a sixth embodiment.

FIG. 28 is a flowchart illustrating a learning processing procedure of the machine learning device related to the additive manufacturing apparatus according to the sixth embodiment.

FIG. 29 is a block diagram illustrating a configuration of an inference device related to the additive manufacturing apparatus according to the sixth embodiment.

FIG. 30 is a flowchart illustrating an inference processing procedure of the inference device related to the additive manufacturing apparatus according to the sixth embodiment.

### DESCRIPTION OF EMBODIMENTS

Hereinafter, a wire nozzle, an additive manufacturing apparatus, and an additive manufacturing method according to embodiments will be described in detail with reference to the drawings.

### First Embodiment

### (Description of Basic Configuration of Additive Manufacturing Apparatus)

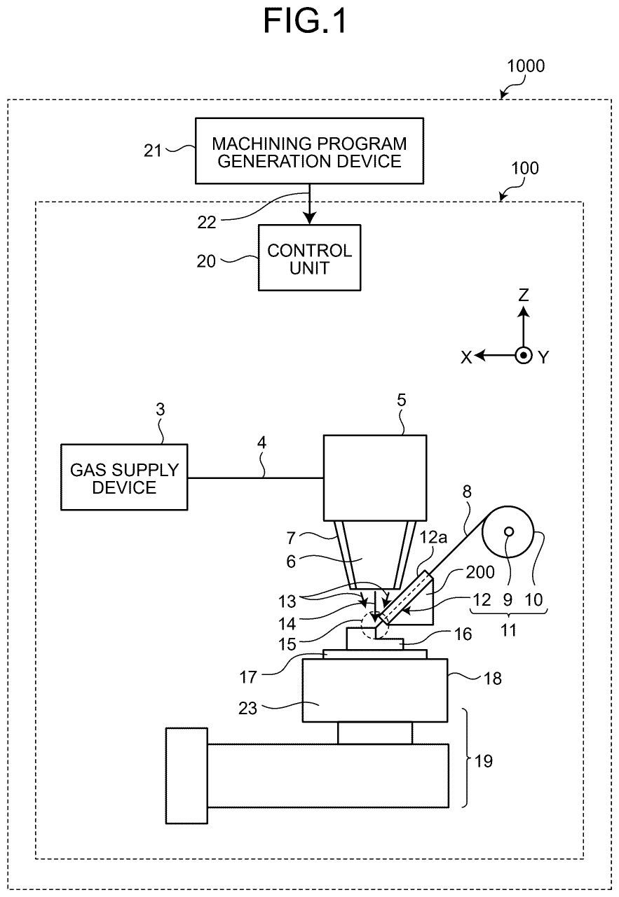

FIG. 1 is a front view illustrating a configuration of an additive manufacturing system 1000 according to a first embodiment. The additive manufacturing system 1000 includes a machining program generation device 21 and an additive manufacturing apparatus 100. The additive manufacturing apparatus 100 is an apparatus with a DED additive manufacturing technique. The machining program generation device 21 generates a basic machining program 22 to be passed to a control unit 20.

The additive manufacturing apparatus 100 includes the control unit 20, a gas supply device 3, a pipe 4, a machining head 5, a heat source supply port 6, a gas nozzle 7, a manufacturing material supply unit 11, a protrusion 200, a stage 18, a rotary member 23, and a rotation mechanism 19. The manufacturing material supply unit 11 includes a rotary motor 9, a wire spool 10, and a wire nozzle 12.

On the basis of the basic machining program 22 generated by the machining program generation device 21, the additive manufacturing apparatus 100 executes additive manufacturing in which a manufacturing material 8 is melted with a heat source 14 and added to a base material 17, a deposit 16, and the like. The base material 17 is placed on the rotation mechanism 19, and the deposit 16 is placed on the base material 17. The additive manufacturing apparatus 100 supplies the manufacturing material 8 to a machining region 15 by the manufacturing material supply unit 11 including the rotary motor 9, the wire spool 10, and the wire nozzle 12. The wire nozzle 12 includes a wire tube portion 12a having a tubular shape in which an inner wall and an outer wall are concentrically formed with respect to a central axis. The manufacturing material 8 is wound around the wire spool 10, passes through the inner wall of the wire tube portion 12a, and is guided to the machining region 15. When the wire spool 10 is rotated by the rotary motor 9, the manufacturing material 8 is supplied to the machining region 15.

A shielding gas 13 is supplied from the gas supply device 3. The shielding gas 13 is sent to the gas nozzle 7 via the pipe 4 and sprayed to the machining region 15 from above. The type of the shielding gas 13 includes inert gas such as argon, nitrogen, carbon dioxide, or the like.

The wire nozzle 12 is disposed within a range through which the shielding gas 13 passes. The protrusion 200 is attached to the wire tube portion 12a of the wire nozzle 12. Examples of the material of the manufacturing material 8 supplied from the wire nozzle 12 include metal and resin. The manufacturing material 8 is not limited to a wire, and may be a powder material that is ejected with high-pressure air or the like. Examples of the form of the manufacturing material 8 include wire, powder, and liquid. The protrusion 200 is attached to the wire tube portion 12a at a position corresponding to a leeward side of the shielding gas 13. Alternatively, the wire tube portion 12a and the protrusion 200 may be integrated. In this case, in cutting processing, it is difficult to achieve accuracy due to reasons such as distortion of the wire tube portion 12a, and the difficulty of manufacturing is high so that manufacturing can be done by fabricating a component using a three dimensions (3D) printer. Examples of the material of the protrusion 200 include metal materials such as copper, SUS, and Al. Chromium copper or the like may also be used in order to make it difficult for spatter generated during manufacturing to adhere to the protrusion 200.

In FIG. 1, an X-axis direction corresponds to one horizontal direction parallel to a plane of the base material 17. A Y-axis direction corresponds to one direction parallel to the plane of the base material 17 and perpendicular to the X-axis direction. A Z-axis direction corresponds to a vertical direction (height direction) perpendicular to the plane of the base material 17.

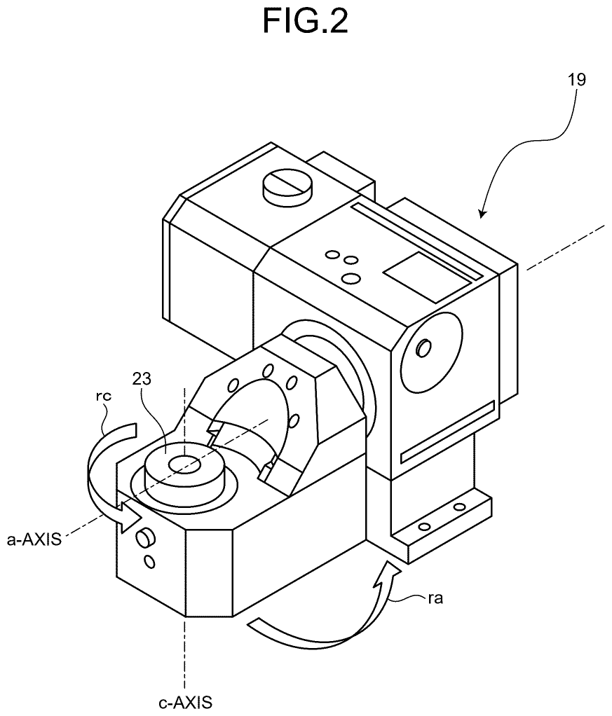

FIG. 2 is a perspective view illustrating an exemplary configuration of the rotation mechanism 19 of the additive manufacturing apparatus 100 according to the first embodiment. The rotation mechanism 19 rotates the base material 17 and the stage 18 about an a-axis and a c-axis on the basis of a drive command determined by the control unit 20. The a-axis is perpendicular to the c-axis. When the stage 18 rotates, the relative angle and position between the base material 17 and the machining head 5 change. The rotation mechanism 19 may include the rotary member 23 that rotates about the a-axis and the c-axis in FIG. 2 as axes of rotation. The stage 18 may be fixed to the rotary member 23. The rotation mechanism 19 may also rotate the rotary member 23 and the stage 18 on the basis of a drive command. For example, the rotation mechanism 19 may be configured to be able to independently rotate two rotary members rotating in a rotation direction “rc” about the c-axis as the axis of rotation and in a rotation direction “ra” about the a-axis as the axis of rotation. The a-axis and the c-axis can be oriented at will. For example, the a-axis may be parallel to the X axis, and the c-axis may be parallel to the Z axis. Moreover, for example, the rotation mechanism 19 may include a servomotor that executes the two rotations in the rotation direction “ra” and the rotation direction “rc”. By using the rotation mechanism 19, for example, it is possible to perform additive manufacturing to obtain a complicated shape in which a five-axis configuration is required to access a machining position. Alternatively, the rotation mechanism 19 need not be included. For example, the additive manufacturing system 1000 only for the purpose of performing simple manufacturing to get a manufactured object of a wall or a line does not need additive manufacturing using the rotation mechanism.

The machining program generation device 21 may be a computer aided manufacturing (CAM) device that generates the basic machining program 22 for controlling the additive manufacturing apparatus 100. The machining program generation device 21 generates the basic machining program 22 on the basis of external data such as a layer height and shape information. As long as the machining program generation device 21 can generate the basic machining program 22, the external data may be in a computer aided design (CAD) data format or the like.

In FIG. 1, the axis of the wire tube portion 12a of the wire nozzle 12 is oriented to form an acute angle with the plane of the base material 17, but does not always have to maintain the acute angle. Since it is sufficient to guide the manufacturing material 8 to the machining region 15, for example, the relationship between the orientation of the axis of the wire nozzle 12 and the plane of the base material 17 may be perpendicular. FIG. 1 illustrates one piece of the wire nozzle 12, but a plurality of pieces of the wire nozzles 12 may be disposed.

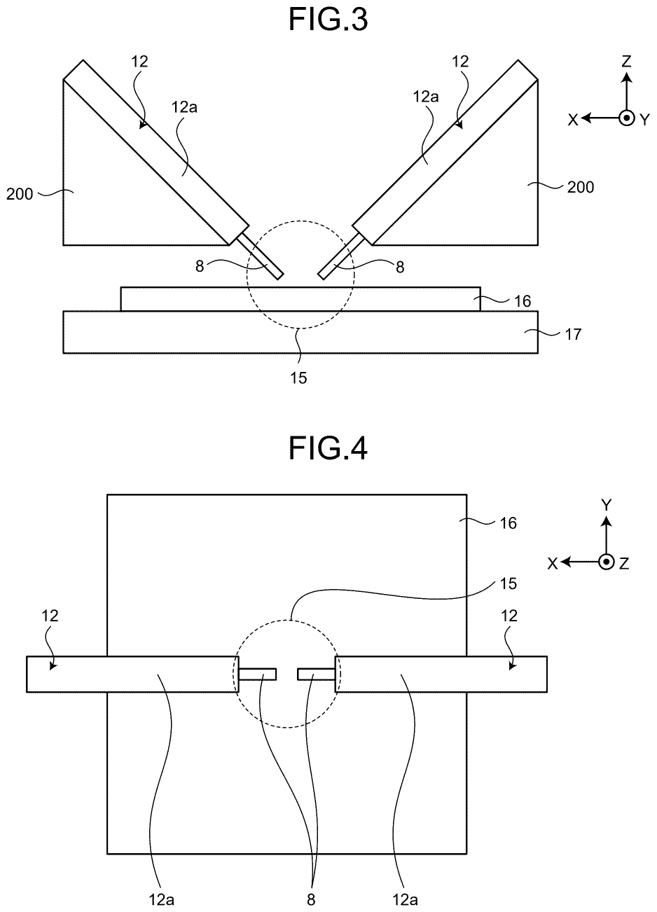

FIG. 3 is a front view illustrating another exemplary placement of the wire nozzle 12 in the additive manufacturing apparatus 100 according to the first embodiment. FIG. 4 is a plan view illustrating the other exemplary placement of the wire nozzle 12 in the additive manufacturing apparatus 100 according to the first embodiment. FIG. 3 is the view of the wire nozzle 12 as viewed from the Y-axis direction, and FIG. 4 is the view of the wire nozzle 12 as viewed from the Z-axis direction. In FIGS. 3 and 4, a plurality of the wire nozzles 12 is disposed. Specifically, two of the wire nozzles 12 are disposed such that tips of two of the manufacturing materials 8 face each other at an angle in the machining region 15. The wire nozzles 12 may be disposed at any positions as long as the manufacturing materials 8 can be supplied to the machining region 15. Different kinds of the manufacturing materials 8 may be supplied from the plurality of the wire nozzles 12. In this case, the kind of the manufacturing material 8 to be used can be selected from the plurality of the wire nozzles 12 and supplied. In a case where the manufacturing materials 8 supplied from the wire nozzles 12 are the same, the manufacturing materials 8 may be simultaneously supplied to the machining region 15 to be melted by the heat source 14 and layered. By doing so, the amount of the manufacturing materials 8 supplied per unit time increases, and if the heat source 14 necessary for melting the manufacturing materials 8 can be supplied to the machining region 15, the manufacturing speed can be further increased so that additive manufacturing can be sped up. Moreover, the wire nozzle 12 may include a mechanism to be rotatable about the axis of the wire nozzle 12. An actuator of this mechanism includes a servo. The wire nozzle 12 being able to rotate can accommodate direction dependency of manufacturing of the wire nozzle 12, and manufacturing can be performed while the wire nozzle 12 is oriented in a direction that makes manufacturing easy.

The base material 17 may use a material different from the manufacturing material 8. In this case, the base material 17 and the manufacturing material 8 may fail to be joined to each other due to a difference in melting point and a difference in material properties such as a rate of absorption of the heat source 14 between the two materials. Solutions for such case include a method of heating the base material 17 in advance with the heat source 14 to improve melting of the base material 17 and the manufacturing material 8 and facilitate joining thereof, and a method of heating by means such as passing a current to the manufacturing material 8.

In FIG. 1, the heat source supply port 6 is attached in a +Z-axis direction as viewed from the base material 17, but the position of the heat source supply port 6 is not limited. For example, the heat source supply port 6 may be attached at a position where the heat source 14 is supplied to the machining region 15 with an axis of the heat source supply port 6 being kept at a non-perpendicular angle with the surface of the base material 17. Also, it is allowable that a plurality of the heat source supply ports 6 are attached. In this case, the heat sources 14 may be simultaneously supplied from the plurality of the heat source supply ports 6 to the machining region 15, or only one of the plurality of the heat source supply ports 6 may supply the heat source 14. With the plurality of the heat source supply ports 6, the heat sources 14 having high output can be supplied. Moreover, when the heat source supply ports 6 supply the heat sources 14 to the machining region 15 from different positions, the base material 17 and the deposit 16 can be directly heated without the heat sources 14 directly hitting the manufacturing material 8, and the melting between the manufacturing material 8 and the base material 17 may be facilitated.

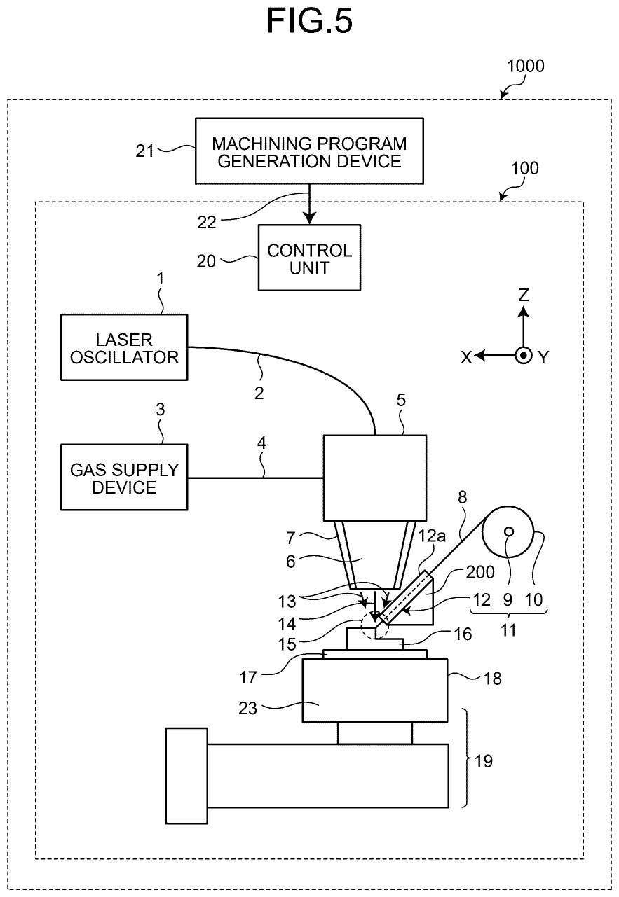

The heat source 14 may be any means as long as the heat source can heat and melt the manufacturing material 8. For example, a case where a laser beam is used as the heat source 14 will be considered. FIG. 5 is a front view illustrating an exemplary configuration in the case where the laser beam is used as the heat source 14 in the additive manufacturing apparatus 100 according to the first embodiment. The laser beam as the heat source 14 is generated by amplifying light by a laser oscillator 1, passes through a fiber cable 2, is supplied to a beam nozzle as the heat source supply port 6, and is output to the machining region 15. The wavelength of the laser beam may be changed at will depending on the manufacturing material 8. For example, in a case where the manufacturing material 8 is copper, a wavelength of a blue laser may be used. As the heat source 14, besides the laser beam, an infrared ray using radiant heat, a heater, or the like may be used in another method to apply heat to the wire nozzle 12, raise the temperature of the manufacturing material 8 to the melting point, and melt the manufacturing material 8. In the method of applying heat to the wire nozzle 12, the heat source supply port 6 is not necessary and thus may be omitted.

### (Procedure of Additive Manufacturing)

The control unit 20 controls to move the machining head 5 to a position on the base material 17 determined by the basic machining program 22 and output the heat source 14 onto the base material 17, thereby melting the manufacturing material 8 supplied from the wire nozzle 12 of the machining head 5 to the machining region 15. At this time, the shielding gas 13 supplied from the gas supply device 3 is sent to the gas nozzle 7 via the pipe 4, and is ejected from the gas nozzle 7 to the machining region 15 from above. Furthermore, the manufacturing material 8 is supplied while the machining head 5 is moved, and the manufacturing material 8 that has been melted is solidified and deposited in a bead shape on the base material 17 by surface tension or viscosity of the manufacturing material 8, whereby the deposit 16 is formed. The manufacturing material 8 is melted on the deposit 16 or the base material 17 and repeatedly solidified in the bead shape to make the deposit 16 into a shape of a desired manufactured object. The deposit 16 in the bead shape made by melting the manufacturing material 8 varies in height and width of the bead shape due to a plurality of factors including the material of the manufacturing material 8, the feed rate, the output of the heat source 14, the speed of moving the machining head 5, the shape of the deposit 16, and the like. Therefore, sensor feedback control may be adopted in which a camera, a thermoviewer, or the like is used to acquire a state of the manufacturing material 8 that has been melted, and on the basis of the information acquired, the speed of the machining head 5 and an output command value for the heat source 14 are changed by the control unit 20. The bead shape may be a line bead shape or a point bead shape.

The additive manufacturing apparatus 100 of the first embodiment can perform additive manufacturing if the manufacturing material 8 can be layered on an arbitrary workpiece, and thus has a high degree of freedom in manufacturing. Surfaces of the base material 17 and the deposit 16, which are the workpieces on which the manufacturing material is layered, are not necessarily flat surfaces, and may be curved surfaces on which the manufacturing material can be layered. Furthermore, in a case where the manufacturing material 8 cannot be layered in a desired direction due to the influence of gravity or the like, the orientation of the base material 17 may be changed by driving the axis of the rotation mechanism 19 so that the layering can be performed.

The additive manufacturing apparatus 100 forms the deposit 16, which is the manufactured object, by layering the manufacturing material 8, but may be used not only for making the manufactured object but also for repairing a defect in a machined object. For example, a partially missing machined object may be repaired. The missing part is filled with the manufacturing material 8 of the machined object by the use of the additive manufacturing apparatus 100. After that, the repaired and raised portion can be polished or the like, whereby the machined object can be restored to the shape before having the defect.

### (Configuration of Wire Nozzle 12 and Protrusion 200)

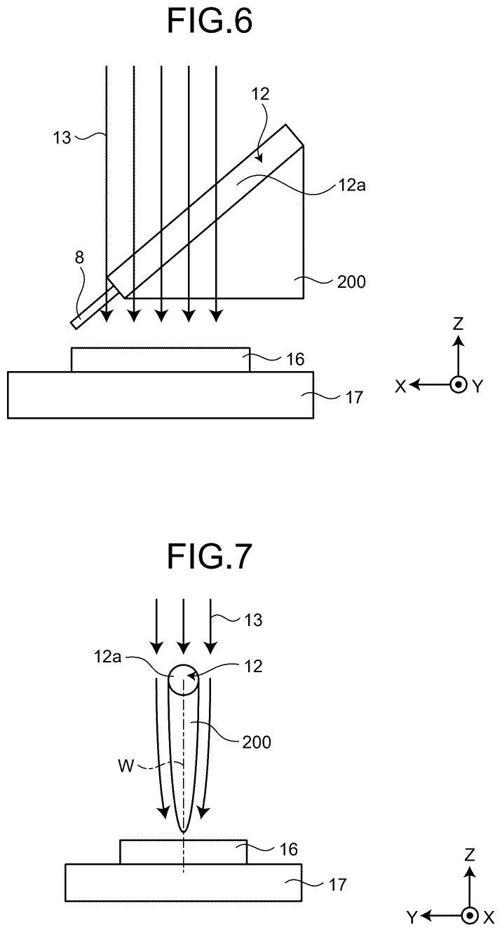

FIG. 6 is a front view illustrating a configuration of the protrusion 200 in the additive manufacturing apparatus 100 according to the first embodiment. FIG. 7 is a side view illustrating the configuration of the wire nozzle 12 and the protrusion 200 in the additive manufacturing apparatus 100 according to the first embodiment. FIG. 6 is the view of the wire nozzle 12 and the protrusion 200 as viewed from the Y-axis direction. FIG. 7 is the view of the wire nozzle 12 and the protrusion 200 as viewed from the X-axis direction.

As illustrated in FIGS. 6 and 7, the protrusion 200 is attached to a lower part of the wire tube portion 12a of the wire nozzle 12. In other words, the protrusion 200 protrudes from the wire tube portion 12a to a downstream side along the direction of flow of the shielding gas 13. In yet other words, the protrusion 200 has a thin plate shape hanging down along the direction of flow of the shielding gas 13 from a part or the entire length of the wire tube portion 12a so as to be positioned on a downstream side of the flow of the shielding gas 13 ejected from the gas nozzle 7. In the first embodiment, the direction of a hanging axis W along which the protrusion 200 hangs down from the wire tube portion 12a coincides with the Z-axis direction that is the direction of flow of the shielding gas 13 in the first embodiment.

The length of a portion of the protrusion 200 protruding from a tip side of the wire tube portion 12a toward the direction of flow of the shielding gas 13 is shorter than the length of another portion of the protrusion 200 protruding from a base end side of the wire tube portion 12a toward the direction of flow of the shielding gas 13. In other words, when viewed from the Y-axis direction, the protrusion 200 has a triangular shape that is long in the X-axis direction and the Z-axis direction with one vertex under the tip of the wire nozzle 12 and another vertex under the base end of the wire nozzle 12.

In addition, the width of the protrusion 200 in the Y-axis direction, which is one of two directions perpendicular to the Z-axis direction in which the shielding gas 13 flows, is set to be smaller than or equal to the diameter of the wire nozzle 12 so as not to slow down the flow of the shielding gas 13. Moreover, in FIGS. 6 and 7, the width of the protrusion 200 in the Y-axis direction is set to taper toward the downstream side of the flow of the shielding gas 13, and the rate of the change in the width is set to increase toward the downstream side of the flow of the shielding gas 13.

The reason why the protrusion 200 is attached to the wire nozzle 12 is to cover the machining region 15 including the portion immediately below the wire tube portion 12a with the shielding gas 13. Therefore, the protrusion 200 is shaped such that the shielding gas 13 ejected from the gas nozzle 7 can flow on the surface of the protrusion 200 to cover the machining region 15 including the portion immediately below the wire nozzle 12.

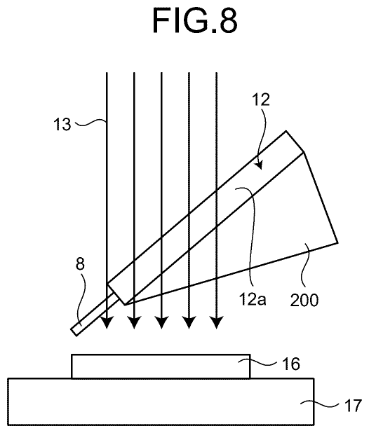

FIG. 8 is a front view illustrating a configuration of a first modification of the protrusion 200 in the additive manufacturing apparatus 100 according to the first embodiment. In FIGS. 6 and 7, the lower portion of the protrusion 200 is parallel to the base material 17, whereas the protrusion 200 in FIG. 8 has a triangular shape in which the lower portion thereof is not parallel to the base material 17. The protrusion 200 may have any shape as long as the shielding gas 13 ejected from the gas nozzle 7 flows along the surface shape of the protrusion 200 and results in covering the machining region 15.

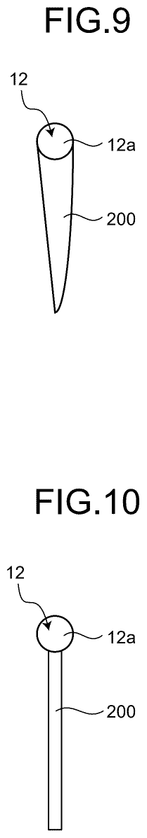

FIG. 9 is a side view illustrating a configuration of a second modification of the protrusion 200 in the additive manufacturing apparatus 100 according to the first embodiment. FIG. 10 is a side view illustrating a configuration of a third modification of the protrusion 200 in the additive manufacturing apparatus 100 according to the first embodiment. The protrusions 200 in FIGS. 6 and 7 are bilaterally symmetrical with respect to an XZ plane, but need not be bilaterally symmetrical. For example, as illustrated in FIG. 9, the protrusion 200 may have a bilaterally asymmetrical shape with one surface being a flat surface and another surface being a curved surface. Moreover, the width of the protrusion 200 in the Y-axis direction does not need to taper toward the downstream side of the flow of the shielding gas 13 as in FIG. 7, and the protrusion 200 may have portions having the same width. For example, as illustrated in FIG. 10, the protrusion 200 having a flat plate shape with a thickness smaller than the outer diameter of the wire nozzle 12 may be attached.

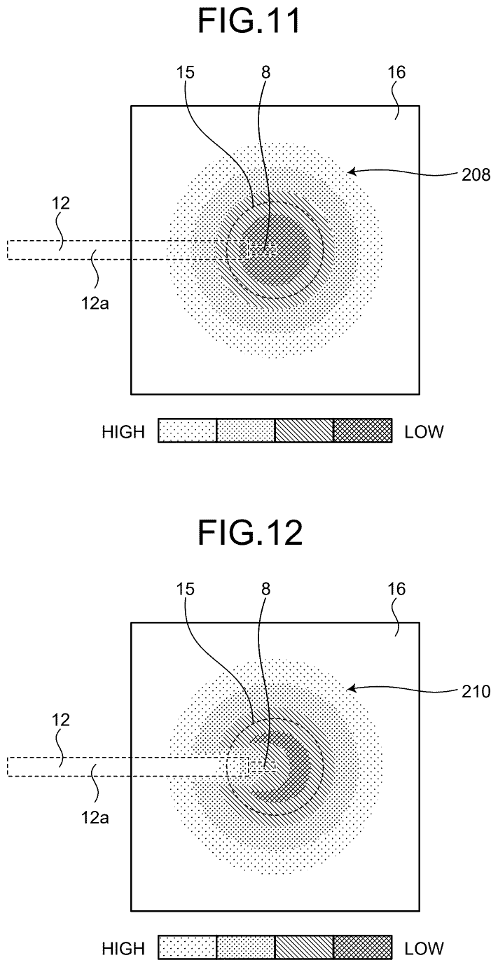

FIG. 11 is a plan view illustrating an example of an oxygen concentration distribution 208 on a surface of the deposit 16 in the additive manufacturing apparatus 100 according to the first embodiment. FIG. 12 is a plan view illustrating an example of an oxygen concentration distribution 210 on the surface of the deposit 16 in a comparative example in which the protrusion 200 is not attached to the wire nozzle 12. In the case of FIG. 11, although not illustrated, the protrusion 200 is attached to the wire nozzle 12. As can be seen from the comparison between FIGS. 11 and 12, by attaching the protrusion 200, the oxygen concentration in the area below the wire tube portion 12a can be reduced. In the case where the protrusion 200 is absent, when the shielding gas 13 is ejected from the gas nozzle 7 to the machining region 15, the wire tube portion 12a becomes an obstacle so that the machining region 15 has a region not covered with the shielding gas 13. By attaching the protrusion 200, the shielding gas 13 flows along the surface of the protrusion 200, and the region in the machining region 15 not covered with the shielding gas 13 when the protrusion 200 is absent can be covered with the shielding gas 13, whereby the effect of inhibiting oxidation of the deposit 16 in the machining region 15 can be improved.

As described above, the first embodiment includes the protrusion 200 that has the plate shape with the width smaller than or equal to the outer diameter of the wire tube portion 12a and protrudes from the wire tube portion 12a toward the downstream side along the direction of flow of the shielding gas 13, whereby the shielding gas 13 ejected from the gas nozzle 7 flows on the surface of the protrusion 200, and the machining region 15 including the portion immediately below the wire nozzle 12 can be covered with the shielding gas 13. This as a result can sufficiently shield the machining region 15 from entry of the air with the simple and inexpensive structure. Moreover, the width of the protrusion 200 in the Y-axis direction is set to taper toward the downstream side of the flow of the shielding gas 13, and the rate of the change in the width is set to increase toward the downstream side of the flow of the shielding gas 13, whereby the region of the manufactured object hidden by the wire tube portion 12a can be efficiently covered with the shielding gas.

### Second Embodiment

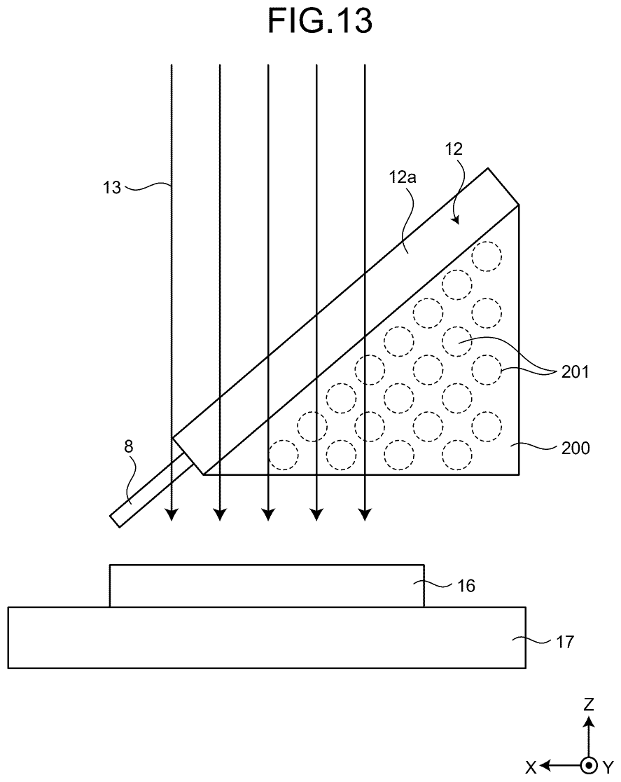

FIG. 13 is a front view illustrating a configuration of the wire nozzle 12 and the protrusion 200 according to a second embodiment. In the second embodiment, a surface of the protrusion 200 has been treated to have irregularities, and dimples 201 that are a plurality of recesses are provided on the surface of the protrusion 200. The other configurations in the second embodiment are the same as those in the first embodiment, and redundant description will be omitted. The depression of the dimple 201 can have an arc shape, a conical shape, a trapezoidal shape, or the like. The number, shape, and size of the dimples 201 are appropriately set depending on the flow rate of the shielding gas 13 flowing on the surface of the protrusion 200 and the size of the protrusion 200. For example, the size of the outer diameter of the dimple 201 is 1/10 of the length of the axis of the wire tube portion 12a, the shape of the depression is an arc, the depth of the depression is ½ of the outer diameter of the dimple 201, and the distance between the centers of the dimples 201 is 3/2 of the outer diameter of the dimple 201.

The dimples 201 on the surface of the protrusion 200 disturb the shielding gas 13 flowing on the surface of the protrusion 200, and the flow rate near the surface is less easily reduced. As a result, the shielding gas 13 less easily separates from the surface. In order to obtain the effect of the dimples 201, the shielding gas 13 desirably flows at the flow rate at which a laminar flow is achieved. Depending on the size and shape of the protrusion 200 or the type and flow rate of the shielding gas 13, the number, size, and shape of the dimples 201 appropriate for causing the flow of the shielding gas 13 to separate on a more leeward side of the protrusion 200 change. Therefore, the protrusion 200 with the dimples 201 having appropriate size and shape may be used depending on the situation. One method of obtaining the protrusion 200 that is appropriate is to examine the position of the separation for a variety of the protrusions 200. The position of the separation can be examined by various methods including, for example, Schlieren flow visualization.

As described above, according to the second embodiment, the dimples 201 are provided on the surface of the protrusion 200 so that the following effect is obtained in addition to the effect of the first embodiment. That is, as compared with the case where the dimples 201 are absent, the shielding gas 13 separates from the surface of the protrusion 200 on the more leeward side, so that the machining region 15 located immediately below the wire nozzle 12 can be more reliably covered with the shielding gas 13, which improves the effect of inhibiting oxidation of the deposit 16 as the workpiece.

### Third Embodiment

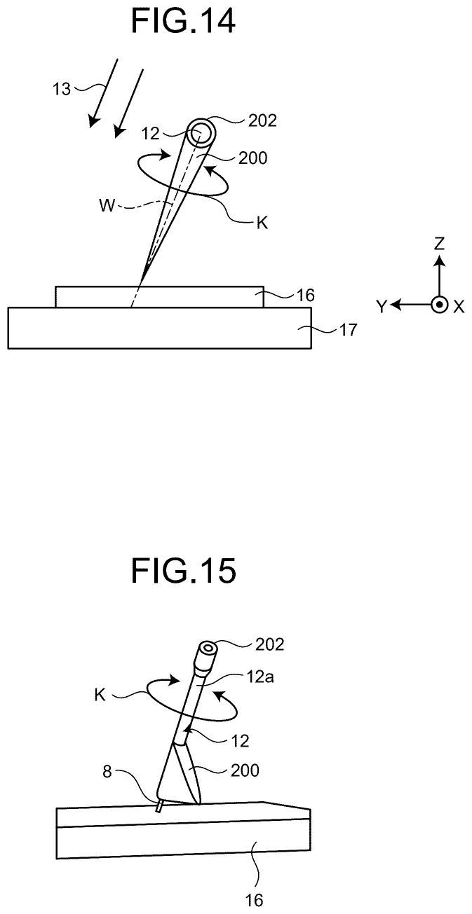

FIG. 14 is a side view illustrating a configuration of the wire nozzle 12 and the protrusion 200 according to a third embodiment. FIG. 15 is a perspective view illustrating the configuration of the wire nozzle 12 and the protrusion 200 according to the third embodiment. In the third embodiment, a joint 202 that allows the protrusion 200 to rotate about the axis of the wire tube portion 12a is provided. Thus, in the third embodiment, even when the direction of flow of the shielding gas 13 ejected from the gas nozzle 7 changes, the effect of inhibiting oxidation can be maintained. The other configurations in the third embodiment are the same as those in the first embodiment, and redundant description will be omitted.

The joint 202 is attached to an outer peripheral portion of the wire tube portion 12a, and rotates with respect to the wire tube portion 12a about the axis of the wire tube portion 12a as indicated by an arrow K. The protrusion 200 is fixed to the joint 202 that rotates. The joint 202 rotates such that the hanging axis W of the protrusion 200 coincides with the direction of flow of the shielding gas 13. The joint 202 may be either a passive joint without an actuator or an active joint with an actuator. In the case of the passive joint, the joint rotates such that the hanging axis W of the protrusion 200 coincides with the direction of flow of the shielding gas 13. In the case of the active joint, the actuator attached to the joint 202 of the wire nozzle 12 drives the protrusion 200 to rotate to coincide with the direction of flow of the shielding gas 13. The actuator of the active joint includes a motor.

In the case where the joint 202 is the passive joint, the joint 202 passively rotates such that the hanging axis W is oriented in the direction of flow of the shielding gas 13, whereby the shielding gas 13 can flow along the protrusion 200 without separating from the surface of the protrusion 200. Therefore, as compared to the case where the wire nozzle 12 and the protrusion 200 are fixed without the joint 202, the machining region 15 located below the wire nozzle 12 can be more reliably covered with the shielding gas 13, which improves the effect of inhibiting oxidation of the deposit 16 as the workpiece. When the flow of the shielding gas 13 is highly irregular and cannot be followed by the protrusion 200, a lubricant such as lubricating oil may be applied to the joint 202. With the lubricant being applied, the joint 202 has less frictional resistance and more easily follows the flow of the shielding gas 13. In addition, in a case where the protrusion 200 is lightweight and changes its orientation greatly due to a change in the flow of the shielding gas 13, an elastic body such as a coil spring may be placed in the joint 202. With the elastic body placed in the joint 202, the protrusion 200 does not need to sensitively react to an ignorable change in the flow of the shielding gas 13, which results in preventing disturbance.

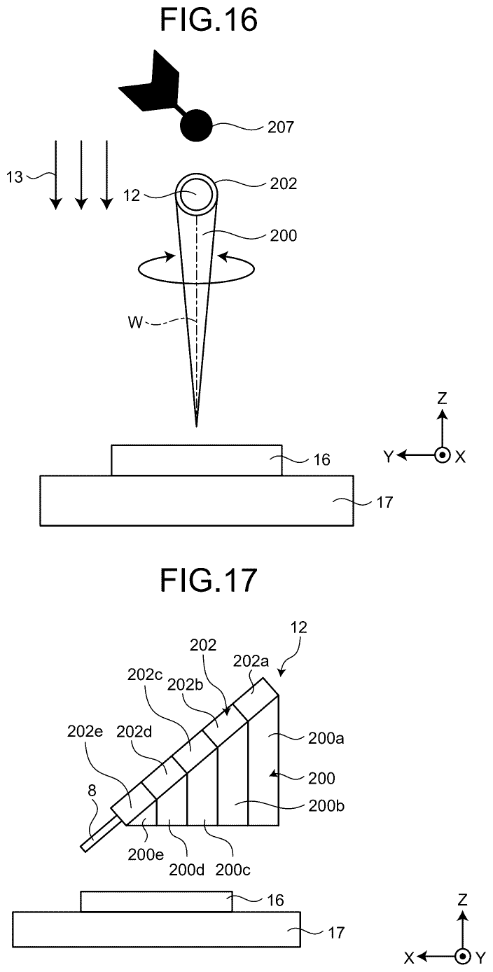

FIG. 16 is a side view illustrating another configuration of the additive manufacturing apparatus 100 according to the third embodiment. FIG. 16 illustrates an exemplary configuration in the case where the joint 202 is the active joint. A wind direction sensor 207 is installed on the windward side of the flow of the shielding gas 13 as viewed from the protrusion 200. In this configuration, the wind direction sensor 207 detects the direction of flow of the shielding gas 13 through the protrusion 200, and the joint 202 is driven to rotate such that the orientation of the hanging axis W of the protrusion 200 coincides with the detected direction of flow of the shielding gas 13. As a result, the shielding gas 13 can flow along the protrusion 200 without separating from the surface of the protrusion 200. The wind direction sensor 207 may be disposed at any position as long as the direction of flow of the shielding gas 13 through the protrusion 200 can be detected.

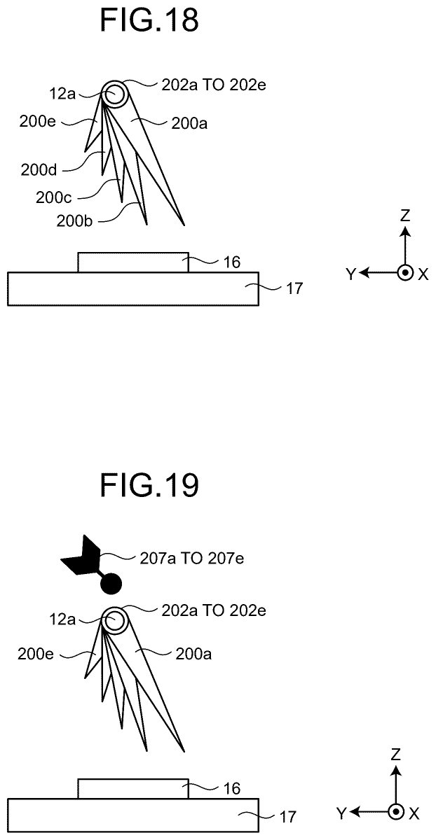

FIG. 17 is a front view illustrating another configuration of the wire nozzle 12 and the protrusion 200 according to the third embodiment. FIG. 18 is a side view illustrating the other configuration of the wire nozzle 12 and the protrusion 200 according to the third embodiment. FIG. 19 is a side view illustrating yet another configuration of the additive manufacturing apparatus 100 according to the third embodiment. In FIGS. 17, 18, and 19, the protrusion 200 is divided into a plurality of protrusions 200a to 200e, the joint 202 is divided into a plurality of joints 202a to 202e, and the protrusions 200a to 200e can be independently rotated by corresponding ones of the joints 202a to 202e.

The joints 202a to 202e may be either passive joints or active joints. As illustrated in FIGS. 17 and 18, in the case where the joints 202a to 202e are the passive joints, the protrusions 200a to 200e are independently rotated along the direction of flow of the shielding gas 13 ejected from the gas nozzle 7. As illustrated in FIG. 19, when the joints 202a to 202e are the active joints, wind direction sensors 207a to 207e are separately installed above the divided protrusions 200a to 200e, respectively, and the wind direction sensors 207a to 207e each detect the direction of flow of the shielding gas 13. The protrusions 200a to 200e are rotated in accordance with the corresponding detected directions of the shielding gas 13. According to this configuration, as compared with the case where the protrusion 200 is not divided, each of the protrusions 200a to 200e is rotated in accordance with a more local flow of the shielding gas 13, so that a larger amount of the shielding gas 13 can flow along the surfaces of the protrusions 200a to 200e, which can further increase the effect of inhibiting oxidation of the deposit 16 as the workpiece.

As described above, according to the fourth embodiment, the joint 202 is provided to rotate such that the hanging axis W of the protrusion 200 coincides with the direction of flow of the shielding gas 13, so that even when the direction of flow of the shielding gas 13 changes, the shielding gas 13 can go around to the back side of the wire tube portion 12a, which further improves the effect of inhibiting oxidation of the deposit 16 as the workpiece.

### Fourth Embodiment

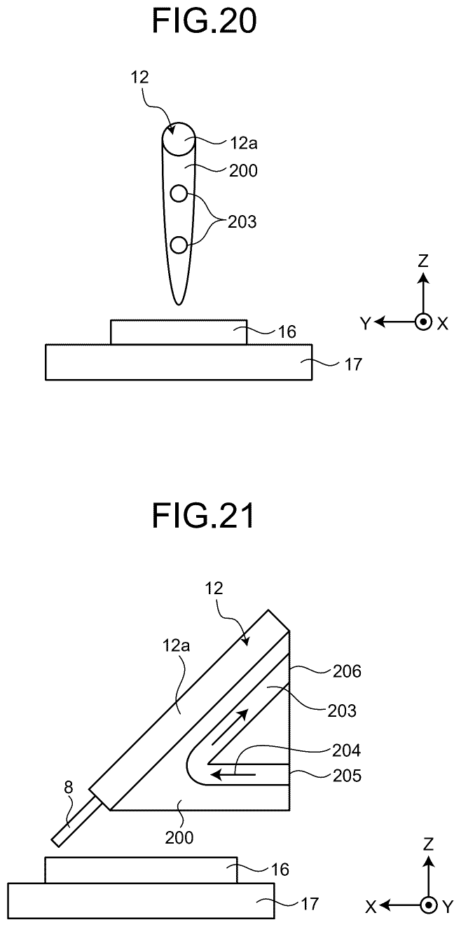

FIG. 20 is a side view illustrating a configuration of the wire nozzle 12 and the protrusion 200 according to a fourth embodiment. FIG. 21 is a front view illustrating the configuration of the wire nozzle 12 and the protrusion 200 according to the fourth embodiment. In the fourth embodiment, a configuration is added for preventing or reducing a temperature rise of the wire nozzle 12 and the protrusion 200 due to heat by the heat source 14, reflected heat, and spatter generated during manufacturing. The other configurations in the fourth embodiment are the same as those in the first embodiment, and redundant description will be omitted.

In the fourth embodiment, a flow path 203 through which a refrigerant 204 flows is provided inside the protrusion 200. The flow path 203 includes an inlet 205 through which the refrigerant 204 enters the protrusion 200 and an outlet 206 through which the refrigerant exits from the protrusion 200 to the outside. The refrigerant 204 enters the protrusion 200 through the inlet 205, passes through the flow path 203, and exits to the outside of the protrusion 200 through the outlet 206. The flow path 203 illustrated in FIGS. 20 and 21 has a shape in which the inlet 205 and the outlet 206 are circular with a sweep formed therebetween, but is not necessarily limited to such a configuration.

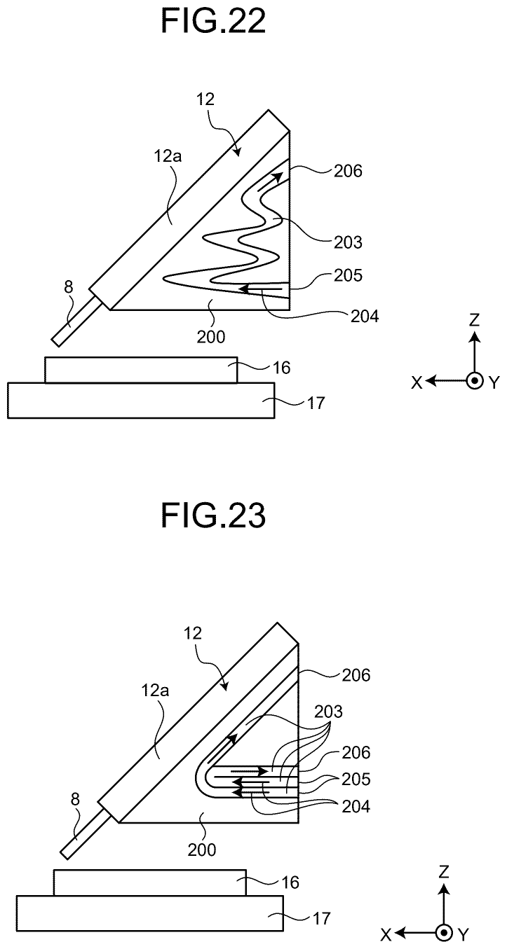

FIG. 22 is a front view illustrating a configuration of a first modification of the wire nozzle 12 and the protrusion 200 according to the fourth embodiment. FIG. 23 is a front view illustrating a configuration of a second modification of the wire nozzle 12 and the protrusion 200 according to the fourth embodiment. In the first modification illustrated in FIG. 22, the flow path 203 meanders such that the refrigerant 204 passes through the inside of the protrusion 200 extensively. A cross-sectional shape of the flow path 203 is not necessarily uniform as long as the refrigerant 204 flows through the flow path 203. In manufacturing a shape in which the shape of the flow path 203 is complicated and difficult to manufacture by cutting or casting as with the protrusion 200 in FIG. 22, a manufacturing device such as a 3D printer can be used to manufacture the protrusion 200 with the flow path 203 having the complicated shape.

In FIGS. 20, 21, and 22, a single path of the flow path 203 with the inlet 205 and the outlet 206 is provided in the protrusion 200, but a plurality of the flow paths 203 may be provided. In the second modification illustrated in FIG. 23, the protrusion 200 includes two different paths of the flow paths 203 each having its own inlet 205 and outlet 206. With the plurality of the inlets 205 and the outlets 206 provided, the flow of the refrigerant 204 passing through the inside of the protrusion 200 can be increased, and an effect of cooling the protrusion 200 is expected to be improved. Examples of the refrigerant 204 include water, oil, chlorofluorocarbon, ammonia, and carbon dioxide. The flow path 203 may be provided not only inside the protrusion 200 but also inside the wire tube portion 12a. As a result, the refrigerant 204 can be fed into the wire tube portion 12a, and not only the protrusion 200 but also the wire nozzle 12 can be cooled.

When the heat source 14 emitted from the heat source supply port 6 is reflected by the deposit 16 and the base material 17, or when spatter and reflected heat generated in outputting the heat source 14 to the manufacturing material 8 directly hit the wire nozzle 12 and the protrusion 200, the temperature of the wire nozzle 12 and the protrusion 200 rises. When the refrigerant 204 flows through the flow path 203 provided inside the protrusion 200, heat energy of the protrusion 200 flows to the refrigerant 204. The refrigerant 204 flows to the outside of the protrusion 200 and discharges the heat energy of the wire nozzle 12 and the protrusion 200 to the outside, whereby the temperature rise of the components can be prevented or reduced. Since the temperature rise can be prevented or reduced, distortion of the wire nozzle 12 due to heat can be prevented, and insufficient supply of the manufacturing material 8 due to heat as well as melting of the wire nozzle 12 and the protrusion 200 can be prevented. Note that, even in the case where the protrusion 200 is divided into the plurality of the protrusions 200a to 200e as illustrated in FIGS. 17 to 19, the flow path 203 through which the refrigerant 204 flows may be formed in each of the protrusions 200a to 200e.

As described above, according to the fourth embodiment, the flow path 203 through which the refrigerant 204 flows is provided inside the protrusion 200, so that the temperature rise of each component due to the generated heat and spatter can be prevented or reduced. As a result, distortion of the wire nozzle 12 due to heat, insufficient supply of the manufacturing material 8 due to heat, melting of the wire nozzle 12 and the protrusion 200, and the like can be prevented.

### Fifth Embodiment

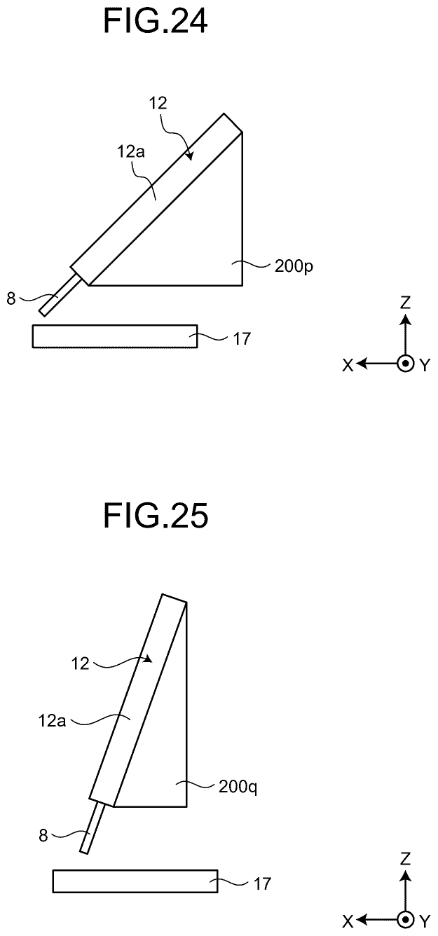

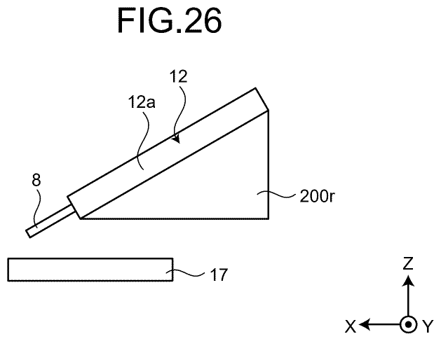

A fifth embodiment can switch among a plurality of the protrusions 200 having different shapes as the angle between the wire tube portion 12a and the base material 17 changes. FIG. 24 is a front view illustrating a state in which a protrusion 200p having a first shape is attached to the wire tube portion 12a in the additive manufacturing apparatus 100 according to the fifth embodiment. FIG. 25 is a front view illustrating a state in which a protrusion 200q having a second shape is attached to the wire tube portion 12a in the additive manufacturing apparatus 100 according to the fifth embodiment. FIG. 26 is a front view illustrating a state in which a protrusion 200r having a third shape is attached to the wire tube portion 12a in the additive manufacturing apparatus 100 according to the fifth embodiment.

The protrusions 200p, 200q, and 200r illustrated in FIGS. 24, 25, and 26 have triangle shapes, in which two sides of the triangle sandwiching one side along the central axis in the wire tube portion 12a have lengths (length in the X-axis direction and length in the Z-axis direction) that are different among the protrusions 200p, 200g, and 200r. In addition, the protrusions 200p, 200q, and 200r have the same distance from a vertex of the triangle corresponding to the tip side of the wire tube portion 12a to the base material 17. The plurality of the protrusions 200p, 200q, and 200r having these different shapes is prepared, and depending on the angle formed by the wire tube portion 12a and the base material 17, a switch operation is performed in which one of the protrusions 200p, 200q, and 200r is selected and connected to the wire tube portion 12a such that a lower portion of the protrusion 200p, 200q, or 200r facing the base material 17 is parallel to the base material 17. By allowing the protrusion 200 to be switched as the angle between the wire tube portion 12a and the base material 17 changes, it is possible to select the protrusion 200p, 200q, or 200r suitable for covering the machining region 15, which is located immediately below the wire nozzle 12, with the shielding gas 13.

The position where each of the protrusions 200p, 200q, and 200r is attached is not limited to the tip of the wire tube portion 12a. For example, a vertex of each of the protrusions 200p, 200q, and 200r may protrude from the tip of the wire tube portion 12a toward a tip of the wire that is the manufacturing material 8. The wire tube portion 12a and the protrusions 200p, 200q, and 200r may be connected by any method as long as the protrusions can be switched and do not come off during manufacturing with no melting or the like of a connecting material. Examples of the connecting material include a magnet, a heat-resistant adhesive, and physical fitting.

In order to automatically change the angle between the wire tube portion 12a and the base material 17, the wire nozzle 12 may be driven by a servo to change the angle between the wire tube portion 12a and the base material 17. Also, if this change in the angle is not a big change in the angle, there is no influence on changing the effect of reducing oxygen, so that the protrusion 200 need not be changed.

The occasion when the protrusion 200 is switched need not be limited to when there is a change in the angle between the orientation of the axis of the wire tube portion 12a and the plane of the base material 17. For example, depending on the shape of the deposit 16 as the workpiece, the flow rate of the shielding gas 13 ejected from the gas nozzle 7, or the like, the shape appropriate for covering the machining region 15 with the shielding gas 13 varies. Therefore, when the shape of the deposit 16 as the workpiece or the flow rate of the shielding gas 13 ejected from the gas nozzle 7 changes, the effect of inhibiting oxidation of the machining region 15 can be improved by changing the protrusion 200 to the protrusion 200p, 200q, or 200r that is appropriate.

As described above, according to the fifth embodiment, as the angle between the wire tube portion 12a and the base material 17 changes, one of the plurality of the protrusions 200 having different shapes is selected, so that it is possible to select a protrusion appropriate for the inclination of the wire tube portion 12a and further improve the effect of inhibiting oxidation of the machining region 15.

### Sixth Embodiment

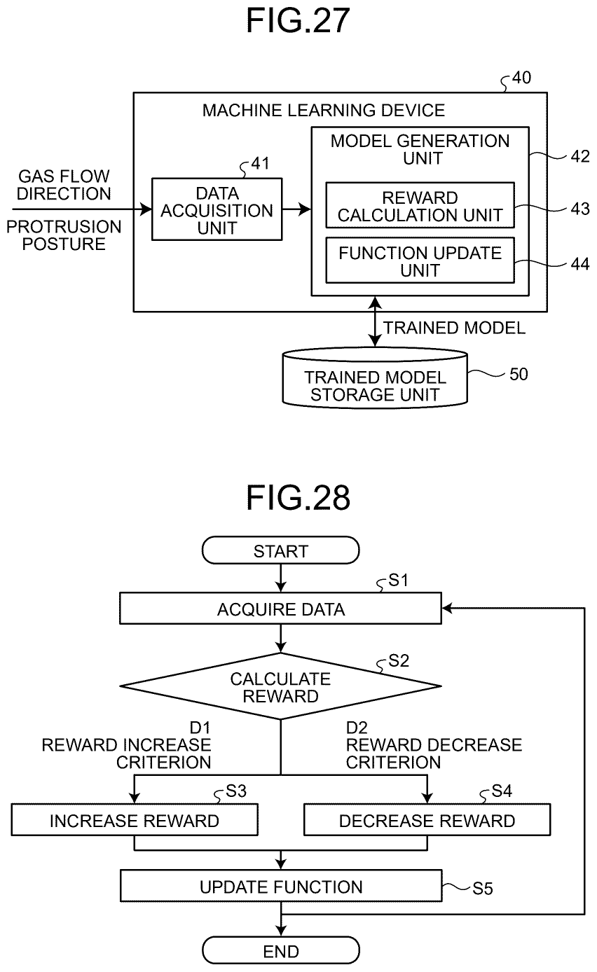

FIG. 27 is a block diagram illustrating a configuration of a machine learning device 40 related to the additive manufacturing apparatus 100 according to a sixth embodiment. The machine learning device 40 includes a data acquisition unit 41 that is a first data acquisition unit and a model generation unit 42.

The data acquisition unit 41 acquires, as learning data, the posture of the protrusion 200 that actively moves about the axis of the wire nozzle 12 and the direction of flow of the shielding gas 13 acquired by the wind direction sensor 207. The model generation unit 42 learns the posture of the protrusion 200 in the direction of flow of the shielding gas 13 on the basis of the learning data including the posture of the protrusion 200 that actively moves about the axis of the wire nozzle 12 and the direction of flow of the shielding gas 13 acquired by the wind direction sensor 207. That is, the model generation unit 42 generates a trained model that infers the posture of the protrusion 200 in the direction of flow of the shielding gas 13 acquired by the wind direction sensor 207.

A learning algorithm used by the model generation unit 42 can be a known algorithm such as supervised learning, unsupervised learning, or reinforcement learning. As an example, a case where reinforcement learning is applied will be described. In reinforcement learning, an agent (subject of action) in a certain environment observes a current state (environmental parameter) and determines an action to be taken. The environment dynamically changes by the action of the agent, and the agent is given a reward according to the change in the environment. The agent repeats this and learns an action policy that maximizes the reward through a series of actions. As representative methods of reinforcement learning, Q-learning and TD-learning are known. In the case of Q-learning, for example, a general update formula of an action-value function Q (s, a) is expressed by Formula (1).

$$\begin{matrix}Formula 1 & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 1 )\end{matrix}$$

In Formula (1), “sₜ” represents a state of the environment at time “t”, and “aₜ” represents an action at time “t”. The state transitions to “sₜ₊₁” by the action “aₜ”. Moreover, “rₜ₊₁” represents a reward given as a result of the change in the state, “γ” represents a discount factor, and “α” represents a learning rate. Note that “γ” is in a range of 0<γ≤1, and “α” is in a range of 0<α≤1. The posture of the protrusion 200 that actively moves about the axis of the wire nozzle 12 corresponds to the action “aₜ”, the direction of flow of the shielding gas 13 acquired by the wind direction sensor 207 corresponds to the state “sₜ”, and the best action “aₜ” in the state “sₜ” at time “t” is learned.

The update formula expressed by Formula (1) increases an action value “Q” if the action value “Q” of the action “aₜ₊₁” having the highest Q value at time “t+1” is higher than the action value “Q” of the action “aₜ” taken at time “t”, or decreases the action value “Q” in the opposite case. In other words, the action-value function Q (s, a) is updated such that the action value “Q” of the action “aₜ” at time “t” approaches the best action value “Q” at time “t+1”. As a result, the best action value in a certain environment sequentially propagates to action values in previous environments.

As described above, in the case where the trained model is generated by reinforcement learning, the model generation unit 42 includes a reward calculation unit 43 and a function update unit 44.

The reward calculation unit 43 calculates the reward “r” on the basis of the oxygen content of the manufactured object. The reward “r” is calculated by a method that increases the reward “r” as the oxygen content of the manufactured object decreases.

According to the reward “r” calculated by the reward calculation unit 43, the function update unit 44 updates the function for determining the posture of the protrusion 200 in the direction of flow of the shielding gas 13, and outputs the function to a trained model storage unit 50. In the case of Q-learning, for example, the action-value function Q (sₜ, aₜ) expressed by Formula (1) is used as the function for calculating the posture of the protrusion 200 corresponding to the direction of flow of the shielding gas 13.

The above learning is repeatedly executed. The trained model storage unit 50 stores the action-value function Q (sₜ, aₜ), that is, the trained model updated by the function update unit 44.

Next, learning processing by the machine learning device 40 will be described with reference to FIG. 28. FIG. 28 is a flowchart illustrating a learning processing procedure of the machine learning device 40 related to the additive manufacturing apparatus 100 according to the sixth embodiment.

In step S1, the data acquisition unit 41 acquires, as the learning data, the posture of the protrusion 200 that actively moves about the axis of the wire nozzle 12 and the direction of flow of the shielding gas 13 acquired by the wind direction sensor 207.

In step S2, the model generation unit 42 determines whether to increase the reward “r” or decrease the reward “r” on the basis of the oxygen content of the manufactured object. The model generation unit 42 determines whether to increase the reward or decrease the reward on the basis of predetermined reward criteria D (general term for D1 and D2).

If determining to increase the reward “r”, the reward calculation unit 43 increases the reward “r” in step S3. For example, in a case where the oxygen content satisfies a reward increase criterion D1, the reward calculation unit 43 increases the reward “r” (for example, gives a reward of “1”). On the other hand, if determining to decrease the reward “r”, the reward calculation unit 43 decreases the reward “r” in step S4. For example, in a case where the oxygen content satisfies a reward decrease criterion D2, the reward calculation unit 43 decreases the reward “r” (for example, gives a reward of “−1”).

In step S5, on the basis of the reward “r” calculated by the reward calculation unit 43, the function update unit 44 updates the action-value function Q (sₜ, aₜ) expressed by Formula (1) stored in the trained model storage unit 50.

The machine learning device 40 repeatedly executes the processing from step S1 to step S5 described above, and stores the generated action-value function Q (sₜ, aₜ) as the trained model in the trained model storage unit 50.

Although the machine learning device 40 according to the sixth embodiment stores the trained model in the trained model storage unit 50 provided outside the machine learning device 40, the trained model storage unit 50 may be included inside the machine learning device 40.

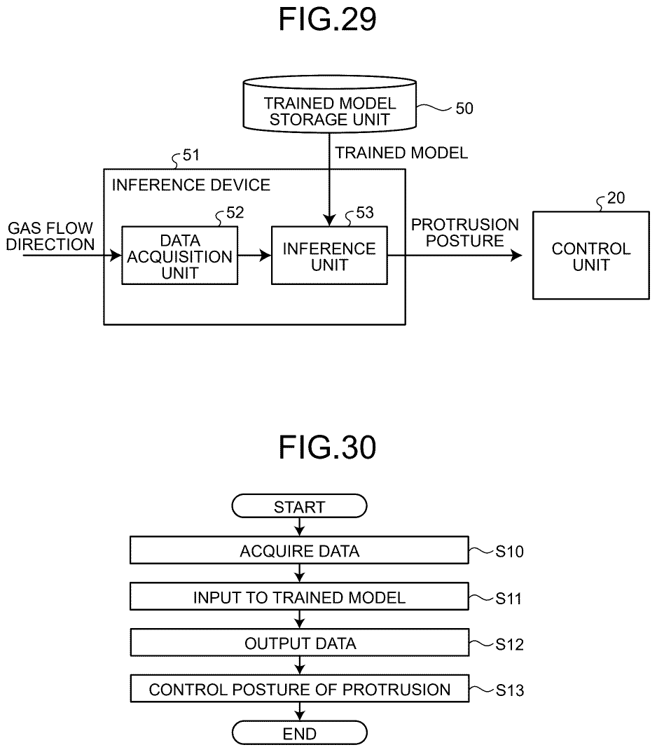

FIG. 29 is a block diagram illustrating a configuration of an inference device 51 related to the additive manufacturing apparatus 100 according to the sixth embodiment. The inference device 51 includes a data acquisition unit 52 that is a second data acquisition unit and an inference unit 53.

The data acquisition unit 52 acquires the direction of flow of the shielding gas 13 acquired by the wind direction sensor 207.

The inference unit 53 uses the trained model stored in the trained model storage unit 50 to infer the posture of the protrusion 200 corresponding to the direction of flow of the shielding gas 13 acquired by the data acquisition unit 52. That is, by inputting the direction of flow of the shielding gas 13, which is a value detected by the wind direction sensor 207 and acquired by the data acquisition unit 52, to the trained model, the inference unit 53 can infer the posture of the protrusion 200 appropriate for the direction of flow of the shielding gas 13 acquired by the wind direction sensor 207.

Note that the sixth embodiment has described that the trained model learned by the model generation unit 42 related to the additive manufacturing apparatus 100 is used to output the posture of the protrusion 200 corresponding to the input state, but the trained model may be acquired from another additive manufacturing apparatus, and the posture of the protrusion 200 corresponding to the input state may be output on the basis of that trained model.

Next, the operation of the inference device 51 will be described with reference to FIG. 30. FIG. 30 is a flowchart illustrating an inference processing procedure of the inference device 51 related to the additive manufacturing apparatus 100 according to the sixth embodiment.

In step S10, the data acquisition unit 52 acquires the direction of flow of the shielding gas 13 detected by the wind direction sensor 207.

In step S11, the inference unit 53 inputs, to the trained model stored in the trained model storage unit 50, the direction of flow of the shielding gas 13 acquired by the wind direction sensor 207 and obtains the posture of the protrusion 200 corresponding to the direction of flow that has been input.

In step S12, the inference unit 53 outputs the obtained posture of the protrusion 200 to the control unit 20 of the additive manufacturing apparatus 100.

In step S13, the control unit 20 of the additive manufacturing apparatus 100 controls the posture of the protrusion 200 so as to achieve the input posture of the protrusion 200.

Note that the sixth embodiment has described the case where reinforcement learning is applied as the learning algorithm used by the inference unit 53, but the learning algorithm is not limited thereto. Besides reinforcement learning, it is also possible to apply supervised learning, unsupervised learning, semi-supervised learning, or the like as the learning algorithm.

Also, as the learning algorithm used in the model generation unit 42, deep learning that learns extraction of a feature value itself can be used, or machine learning may be executed according to another known method such as neural network, genetic programming, functional logic programming, or support vector machine.

Note that the machine learning device 40 and the inference device 51 may be, for example, devices that are connected to the additive manufacturing apparatus 100 via a network and are separate from the additive manufacturing apparatus 100. Alternatively, the machine learning device 40 and the inference device 51 may be built in the additive manufacturing apparatus 100. Yet alternatively, the machine learning device 40 and the inference device 51 may be on a cloud server.

Furthermore, the model generation unit 42 may use the learning data acquired from a plurality of the additive manufacturing apparatuses 100 to learn the posture of the protrusion 200 corresponding to the input state. Note that the model generation unit 42 may acquire the learning data from a plurality of the additive manufacturing apparatuses 100 used in the same area, or may use the learning data collected from a plurality of the additive manufacturing apparatuses 100 operating independently in different areas to learn the posture of the protrusion 200 corresponding to the input state. Moreover, the additive manufacturing apparatus 100 from which the learning data is collected can be added or removed along the way. Furthermore, the machine learning device 40 that has learned the posture of the protrusion 200 corresponding to the state input for a certain one of the additive manufacturing apparatus 100 may be applied to a different one of the additive manufacturing apparatus 100, and the posture of the protrusion 200 corresponding to the state input for the different one of the additive manufacturing apparatus 100 may be relearned and updated.

The configurations illustrated in the above embodiments each merely illustrates an example of the content of the present disclosure, and can thus be combined with another known technique or partially omitted and/or modified without departing from the scope of the present disclosure.

### REFERENCE SIGNS LIST

1 laser oscillator; 2 fiber cable; 3 gas supply device; 4 pipe; 5 machining head; 6 heat source supply port; 7 gas nozzle; 8 manufacturing material; 9 rotary motor; 10 wire spool; 11 manufacturing material supply unit; 12 wire nozzle; 12a wire tube portion; 13 shielding gas; 14 heat source; 15 machining region; 16 deposit; 17 base material; 18 stage; 19 rotation mechanism; 20 control unit; 21 machining program generation device; 22 basic machining program; 23 rotary member; 40 machine learning device; 41, 52 data acquisition unit; 42 model generation unit; 43 reward calculation unit; 44 function update unit; 50 trained model storage unit; 51 inference device; 53 inference unit; 100 additive manufacturing apparatus; 200, 200a to 200e, 200p to 200r protrusion; 201 dimple; 202, 202a to 202e joint; 203 flow path; 204 refrigerant; 205 inlet; 206 outlet; 207, 207a to 207e wind direction sensor; 208, 210 oxygen concentration distribution; 1000 additive manufacturing system; W hanging axis.

1. A wire nozzle at least part of which is disposed within a range through which a shielding gas passes, the wire nozzle comprising a wire tube portion to supply a manufacturing material that is in a form of a wire to a machining region that is irradiated with heat for melting the manufacturing material and also supplied with the shielding gas, wherein
the wire nozzle includes a protrusion that is plate-shaped and protrudes from the wire tube portion toward downstream along a direction of flow of the shielding gas, and
a width of the protrusion that is plate-shaped is smaller than or equal to an outer diameter of the wire tube portion.

2. The wire nozzle according to claim 1, wherein
the width of the protrusion
tapers from the wire tube portion toward downstream of the flow of the shielding gas.

3. The wire nozzle according to claim 1, wherein
the wire tube portion is disposed at an angle with respect to a base material on which a manufactured object is disposed, and
a length of a portion of the protrusion protruding from a tip side of the wire tube portion toward the direction of flow of the shielding gas, is shorter than a length of another portion of the protrusion protruding from a base end side of the wire tube portion toward the direction of flow of the shielding gas.

4. The wire nozzle according to claim 3, wherein
the protrusion has a triangular shape.

5. The wire nozzle according to claim 1, wherein
a plurality of recesses is provided on a surface of the protrusion.

6. The wire nozzle according to claim 1, wherein
the protrusion is rotatable with respect to the wire tube portion around a central axis of the wire tube portion.

7. The wire nozzle according to claim 6, wherein
the protrusion is divided into a plurality of protrusions, and each of the plurality of the protrusions divided is independently rotatable around the central axis of the wire tube portion.

8. The wire nozzle according to claim 1, wherein
the protrusion includes a flow path through which a refrigerant flows.

9. An additive manufacturing apparatus comprising:
a heat source supplier to irradiate a machining region with heat for melting a manufacturing material that is in a form of a wire;
a gas supplier to supply a shielding gas to the machining region from above; and
a manufacturing material supplier including a wire nozzle to supply the manufacturing material to the machining region, the wire nozzle including a wire tube portion at least part of which being disposed within a range through which the shielding gas passes, wherein
the additive manufacturing apparatus includes a protrusion that is plate-shaped and protrudes from the wire tube portion toward a direction of flow of the shielding gas, and
a width of the protrusion that is plate-shaped is smaller than or equal to an outer diameter of the wire tube portion.

10. The additive manufacturing apparatus according to claim 9, wherein
the width of the protrusion
tapers from the wire tube portion toward downstream of the flow of the shielding gas.

11. The additive manufacturing apparatus according to claim 9, wherein
the wire tube portion is disposed at an angle with respect to a base material on which a manufactured object is disposed, and
a length of a portion of the protrusion protruding from a tip side of the wire tube portion toward the direction of flow of the shielding gas, is shorter than a length of another portion of the protrusion protruding from a base end side of the wire tube portion toward the direction of flow of the shielding gas.

12. The additive manufacturing apparatus according to claim 11, wherein
the protrusion has a triangular shape.

13. The additive manufacturing apparatus according to claim 9, wherein
a plurality of recesses is provided on a surface of the protrusion.

14. The additive manufacturing apparatus according to claim 9, wherein
the protrusion is rotatable with respect to the wire tube portion around a central axis of the wire tube portion.

15. The additive manufacturing apparatus according to claim 14, wherein
the protrusion is divided into a plurality of protrusions, and each of the plurality of the protrusions divided is independently rotatable around the central axis of the wire tube portion.

16. The additive manufacturing apparatus according to claim 14, comprising:
a wind direction sensor to detect the direction of flow of the shielding gas on a surface of the protrusion;
a machine learning device including:
first data acquisition circuitry to acquire learning data including a value detected by the wind direction sensor and a posture of the protrusion that rotates around a central axis of the wire tube portion; and
model generation circuitry to use the learning data to generate a trained model for inferring the posture of the protrusion corresponding to the value detected by the wind direction sensor from the value detected by the wind direction sensor; and
an inference device including:
second data acquisition circuitry to acquire the value detected by the wind direction sensor; and
inference circuitry to use the trained model to output the posture of the protrusion corresponding to the value detected by the wind direction sensor acquired by the second data acquisition circuitry, wherein
the additive manufacturing apparatus rotationally controls the posture of the protrusion on the basis of the posture of the protrusion output from the inference device.

17. The additive manufacturing apparatus according to claim 9, wherein
the protrusion includes a flow path through which a refrigerant flows.

18. An additive manufacturing method comprising:
disposing at least part of a wire nozzle that includes a wire tube portion and a protrusion within a range through which a shielding gas passes and supplying a manufacturing material to a machining region using the wire nozzle, the protrusion being plate-shaped, protruding from the wire tube portion toward a direction of flow of the shielding gas, and having a width smaller than or equal to an outer diameter of the wire tube portion;
irradiating the machining region with heat for melting the manufacturing material that is in a form of a wire; and
supplying the shielding gas to the machining region from above.

19. The additive manufacturing method according to claim 18, wherein
the protrusion has a shape of a triangle, and
the additive manufacturing method further comprises:
preparing a plurality of the protrusions in which lengths of two sides of the triangle sandwiching one side along a central axis in the wire tube portion are different among the protrusions, and a distance from a vertex of the triangle corresponding to a tip side of the wire tube portion to a base material on which a manufactured object is disposed is the same among the protrusions; and
selecting, in accordance with an angle between the wire tube portion and the base material changes, one of the plurality of the protrusions and connecting the protrusion selected to the wire tube portion such that a side of the triangle facing the base material is parallel to the base material.
